(19) United States
(12) Patent Application Publication
(10) Pub. No.: US 2023/0279192 A1
(43) Pub. Date: Sep. 7, 2023

(54) PROCESS FOR RECYCLING A SOLID ARTICLE INCLUDING A FLUORINATED POLYMER

(71) Applicant: 3M INNOVATIVE PROPERTIES COMPANY, St. Paul, MN (US)

(72) Inventors: Gregg D. Dahlke, St. Paul, MN (US); Denis Duchesne, Woodbury, MN (US); Klaus Hintzer, Kastl (DE); Mark W. Muggli, Emmerting (DE); Thomas W. Schoettle, Wanghausen (AT); Arne Thaler, Emmerting (DE)

(21) Appl. No.: 17/925,672

(22) PCT Filed: Jun. 8, 2021
(86) PCT No.: PCT/IB2021/055046

§ 371 Date: Nov. 16, 2022

Related U.S. Application Data
(60) Provisional application No. 63/036,151, filed on Jun. 8, 2020.

(51) Int. Cl. C08J 11/08; H01M 8/008; H01M 8/1039; H01M 8/1086

(52) U.S. Cl. CPC C08J 11/08; H01M 8/008; H01M 8/1039; H01M 8/1086; C08J 2327/12; H01M 2008/1095

(57) ABSTRACT

The process is described for recycling a heat-treated solid article including a fluorinated polymer having a fluorinated polymer backbone chain and a plurality of groups represented by formula —SO₃Z, wherein Z is independently a hydrogen, an alkali-metal cation, or a quaternary ammonium cation. The heat-treated solid article was previously heated at a temperature of at least 100° C. The process includes heating the heat-treated solid article in the presence of water and base to form a fluorinated polymer salt solution, allowing the fluorinated polymer salt solution to cool, and converting the fluorinated polymer salt solution to fluorinated polymer solution wherein Z is hydrogen by cation exchange.

### CROSS-REFERENCE TO RELATED APPLICATION

This application claims priority to U.S. Provisional Application No. 63/036,151, filed Jun. 8, 2020, the disclosure of which is incorporated by reference in its entirety herein.

### BACKGROUND

Electrochemical devices, including fuel cells and electrolysis cells, typically contain a unit referred to as a membrane electrode assembly (MEA). Such MEA's comprise one or more electrode portions, which include a catalytic electrode material such as, for example, Pt or Pd, in contact with an ion-conductive membrane. Polymer electrolyte membranes (PEMs) are used in electrochemical cells as solid electrolytes. In a typical electrochemical cell, a PEM is in contact with cathode and anode electrodes and transports ions formed at the anode to the cathode, allowing a current of electrons to flow in an external circuit connecting the electrodes. PEMs also find use in chlor-alkali cells wherein brine mixtures are separated to form chlorine gas and sodium hydroxide. The membrane selectively transports sodium cations while rejecting chloride anions.

A variety of polysulfonic acid polymers are known to be cation conductors and rely on the sulfonate functionality (R-SO₃⁻) as the stationary counter charge for the mobile cations (e.g., H+, Li+, and Na+).

During usage over time, ionomer-containing parts exhibit decreased performance due to overheating, blistering, and migration of multi-valent cations (e.g., Fe³⁺, Ca²⁺, and Mg²⁺) into the ionomer. Due to lack of a robust recycling process, the used membranes get incinerated or disposed of special landfills.

A process for the recovery of a perfluorosulfonic acid ionomer from a fuel cell component is described in U.S. Pat. Appl. Pub. No. 2018/0108932 (Coleman et al.). The process includes immersing the component including the perfluorosulfonic acid ionomer in a solvent including an aliphatic diol and heating.

U.S. Pat. No. 4,433,082 (Grot) describes a process for making a liquid composition of a perfluorinated polymer having sulfonic acid or sulfonate groups in a liquid medium by heating the polymer with a mixture of water and a lower alcohol in a closed system. The process is said to be useful for casting films and recovering perfluorinated polymer having sulfonic acid or sulfonate groups from scrap and used articles made from such a polymer.

In GB 1,286,859, published Aug. 23, 1972, ionomer solutions in the acid, salt, or amide form in water-miscible solvents are described, in which the solutions are useful for casting films of the ionomer.

### SUMMARY

Fluorinated ionomers are widely used in many applications: membrane electrode assemblies in fuel cells, redox-flow batteries, water electrolyzers, and NaCl/HCl-electrolysis cells. For many industries in which these devices are used (e.g. automotive industry), it is desirable to establish a feasible recycling technology to recover as much as possible of the valuable fluorinated compounds and other materials (e.g., precious metals).

The present disclosure provides a process for recycling a heat-treated solid article including a fluorinated polymer. The process can be useful, for example, for recycling ionomers from a variety of devices and recovering, for example, ionomers and other valuable components.

In one aspect, the present disclosure provides a process for recycling a heat-treated solid article including a fluorinated polymer having a fluorinated polymer backbone chain and a plurality of groups represented by formula —SO₃Z, wherein Z is independently a hydrogen, an alkali-metal cation, or a quaternary ammonium cation. The heat-treated solid article was previously heated at a temperature of at least 100° C. The process includes heating the heat-treated solid article in the presence of water and base to form a fluorinated polymer salt solution, allowing the fluorinated polymer salt solution to cool, and converting the fluorinated polymer salt solution to fluorinated polymer solution wherein Z is hydrogen by cation exchange.

In another aspect, the present disclosure provides use of the fluorinated polymer solution wherein Z is hydrogen prepared by this method to prepare at least one of a catalyst ink or a membrane.

In this application:

Terms such as “a”, “an” and “the” are not intended to refer to only a singular entity but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

“Alkyl group” and the prefix “alk-” are inclusive of both straight chain and branched chain groups and of cyclic groups. Unless otherwise specified, alkyl groups herein have up to 20 carbon atoms. Cyclic groups can be monocyclic or polycyclic and, in some embodiments, have from 3 to 10 ring carbon atoms.

The terms “aryl” and “arylene” as used herein include carbocyclic aromatic rings or ring systems, for example, having 1, 2, or 3 rings and optionally containing at least one heteroatom (e.g., O, S, or N) in the ring optionally substituted by up to five substituents including one or more alkyl groups having up to 4 carbon atoms (e.g., methyl or ethyl), alkoxy having up to 4 carbon atoms, halo (i.e., fluoro, chloro, bromo or iodo), hydroxy, or nitro groups. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

“Alkylene” is the multivalent (e.g., divalent or trivalent) form of the “alkyl” groups defined above. “Arylene” is the multivalent (e.g., divalent or trivalent) form of the “aryl” groups defined above.

“Arylalkylene” refers to an “alkylene” moiety to which an aryl group is attached. “Alkylarylene” refers to an “arylene” moiety to which an alkyl group is attached.

The terms “perfluoro” and “perfluorinated” refer to groups in which all C—H bonds are replaced by C—F bonds.

The phrase “interrupted by at least one —O— group”, for example, with regard to a perfluoroalkyl or perfluoroalkylene group refers to having part of the perfluoroalkyl or perfluoroalkylene on both sides of the —O— group. For example, —CF₂CF₂—O—CF₂—CF₂— is a perfluoroalkylene group interrupted by an —O—.

All numerical ranges are inclusive of their endpoints and nonintegral values between the endpoints unless otherwise stated (e.g., 1 to 5 includes 1, 1.5, 2, 2.75, 3, 3.80, 4, 5, etc.).

### DETAILED DESCRIPTION

We have found that while fluorinated polymers having a fluorinated backbone chain and a plurality of groups represented by formula —SO₃H or salts thereof dissolve easily in water and alcohol mixtures when they are newly prepared, after having been heated to temperatures of at least 100° C. or at least 150° C., these polymers are typically insoluble in water and water/alcohol mixtures at standard conditions. The present disclosure provides a process for recycling a heat-treated solid article that includes such fluorinated polymers, which are often referred to as ionomers.

The solid article can be any solid including the fluorinated polymer. The solid article can be, for example, a component of a device including at least one of a catalyst ink, a catalyst layer, a gas diffusion layer, a bipolar plate, or a membrane of a membrane electrode assembly, a fuel cell, a humidifier, a water electrolyzer, a chlor-alkali cell, or a redox flow device. Thus, the process of the present disclosure can be carried out on any of these devices. In some embodiments, the solid article consists of the fluorinated polymer.

In some embodiments, the solid article comprises a catalyst ink or polymer electrolyte membrane in a fuel cell or other electrolytic cell. A membrane electrode assembly (MEA) is the central element of a proton exchange membrane fuel cell, such as a hydrogen fuel cell. Fuel cells are electrochemical cells which produce usable electricity by the catalyzed combination of a fuel such as hydrogen and an oxidant such as oxygen. Typical MEA's comprise a polymer electrolyte membrane (PEM) (also known as an ion conductive membrane (ICM)), which functions as a solid electrolyte. One face of the PEM is in contact with an anode electrode layer and the opposite face is in contact with a cathode electrode layer. Each electrode layer includes electrochemical catalysts, typically including platinum metal. Gas diffusion layers (GDL's) facilitate gas transport to and from the anode and cathode electrode materials and conduct electrical current. The GDL may also be called a fluid transport layer (FTL) or a diffuser/current collector (DCC). The anode and cathode electrode layers may be applied to GDL's in the form of a catalyst ink, and the resulting coated GDL's sandwiched with a PEM to form a five-layer MEA.

Alternately, the anode and cathode electrode layers may be applied to opposite sides of the PEM in the form of a catalyst ink, and the resulting catalyst-coated membrane (CCM) sandwiched with two GDL's to form a five-layer MEA. Details concerning the preparation of catalyst inks and their use in membrane assemblies can be found, for example, in U.S. Pat. Publ. No. 2004/0107869 (Velamakanni et al.). In a typical PEM fuel cell, protons are formed at the anode via hydrogen oxidation and transported across the PEM to the cathode to react with oxygen, causing electrical current to flow in an external circuit connecting the electrodes. The PEM forms a durable, non-porous, electrically non-conductive mechanical barrier between the reactant gases, yet it also passes H+ ions readily.

A catalyst ink composition can include a fluorinated polymer as described below in any of its embodiments combined with catalyst particles (e.g., metal particles or carbon-supported metal particles). A variety of catalysts may be useful. Typically, carbon-supported catalyst particles are used. Typical carbon-supported catalyst particles are 50% to 90% carbon and 10% to 50% catalyst metal by weight, the catalyst metal typically comprising platinum for the cathode and platinum and ruthenium in a weight ratio of 2:1 for the anode. However, other metals may be useful, for example, gold, silver, palladium, iridium, rhodium, ruthenium, iron, cobalt, nickel, chromium, tungsten, manganese, vanadium, and alloys thereof. To make an MEA or CCM, catalyst may be applied to the PEM by any suitable means, including both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications. The catalyst ink may be applied to a PEM or a GDL directly, or the catalyst ink may be applied to a transfer substrate, dried, and thereafter applied to the PEM or to the FTL as a decal.

In some embodiments, the catalyst ink includes the fluorinated polymer at a concentration of at least 10, 15, or 20 percent by weight and up to 30 percent by weight, based on the total weight of the catalyst ink. In some embodiment, the catalyst ink includes the catalyst particles in an amount of at least 10, 15, or 20 percent by weight and up to 50, 40, or 30 percent by weight, based on the total weight of the catalyst ink. The catalyst particles may be added to a fluoropolymer dispersion to make a catalyst ink. The resulting catalyst ink may be mixed, for example, with heating. The percent solid in the catalyst ink may be selected, for example, to obtain desirable rheological properties. Examples of suitable organic solvents useful for including in the catalyst ink include, lower alcohols (e.g., methanol, ethanol, isopropanol, n-propanol), polyols (e.g., ethylene glycol, propylene glycol, glycerol), ethers (e.g., tetrahydrofuran and dioxane), diglyme, polyglycol ethers, ether acetates, acetonitrile, acetone, dimethylsulfoxide (DMSO), N,N dimethyacetamide (DMA), ethylene carbonate, propylene carbonate, dimethylcarbonate, diethylcarbonate, N,N-dimethylformamide (DMF), N-methylpyrrolidinone (NMP), dimethylimidazolidinone, butyrolactone, hexamethylphosphoric triamide (HMPT), isobutyl methyl ketone, sulfolane, and combinations thereof. In some embodiments, the catalyst ink contains 0% to 50% by weight of a lower alcohol and 0% to 20% by weight of a polyol. In addition, the ink may contain 0% to 2% of a suitable dispersant.

In some embodiments, the solid article useful in the process of the present disclosure comprises a polymer electrolyte membrane. A fluorinated polymer may be formed into a polymer electrolyte membrane by any suitable method, including casting, molding, and extrusion. The membrane can be cast from a fluoropolymer dispersion including —SO₃Z groups, wherein Z is as defined above, and then dried, annealed, or both. The membrane may also be cast from a suspension. Any suitable casting method may be used, including bar coating, spray coating, slit coating, and brush coating. After forming, the membrane may be annealed, typically at a temperature of 120° C. or higher, more typically 130° C. or higher, most typically 150° C. or higher. After this annealing, the fluorinated polymer is typically insoluble in water and water/alcohol mixtures at standard conditions as we report above. The membrane can also be made by extrusion of a fluorinated polymer precursor, which includes —SO₂F groups instead of —SO₃Z groups. The —SO₂F groups are then hydrolyzed in the membrane. Extrusion is also typically carried out at high temperatures, resulting in insolubility of the membrane after hydrolysis.

A polymer electrolyte membrane can be prepared by obtaining the fluorinated polymer in a fluoropolymer dispersion, optionally purifying the dispersion by ion-exchange purification, and concentrating the dispersion to make a membrane. Typically, if the fluoropolymer dispersion is to be used to form a membrane, the concentration of copolymer is advantageously high (e.g., at least 20, 30, or 40 percent by weight). Often a water-miscible organic solvent is added to facilitate film formation. Examples of water-miscible solvents include, lower alcohols (e.g., methanol, ethanol, isopropanol, n-propanol), polyols (e.g., ethylene glycol, propylene glycol, glycerol), ethers (e.g., tetrahydrofuran and dioxane), ether acetates, acetonitrile, acetone, dimethylsulfoxide (DMSO), N,N dimethyacetamide (DMA), ethylene carbonate, propylene carbonate, dimethylcarbonate, diethylcarbonate, N,N-dimethylformamide (DMF), N-methylpyrrolidinone (NMP), dimethylimidazolidinone, butyrolactone, hexamethylphosphoric triamide (HMPT), isobutyl methyl ketone, sulfolane, and combinations thereof.

Polymer electrolyte membranes can include a salt of at least one of cerium, manganese or ruthenium or one or more cerium oxide or zirconium oxide compounds is added to the acid form of the copolymer before membrane formation. Typically, the salt of cerium, manganese, or ruthenium and/or the cerium or zirconium oxide compound is mixed well with or dissolved within the fluorinated polymer to achieve substantially uniform distribution. The salt of cerium, manganese, or ruthenium may comprise any suitable anion, including chloride, bromide, hydroxide, nitrate, sulfonate, acetate, phosphate, and carbonate. More than one anion may be present. Other salts may be present, including salts that include other metal cations or ammonium cations. Once cation exchange occurs between the transition metal salt and the acid form of the ionomer, it may be desirable for the acid formed by combination of the liberated proton and the original salt anion to be removed. Thus, it may be useful to use anions that generate volatile or soluble acids, for example chloride or nitrate. Manganese cations may be in any suitable oxidation state, including Mn²⁺, Mn³⁺, and Mn⁴⁺, but are most typically Mn²⁺. Ruthenium cations may be in any suitable oxidation state, including Ru³⁺ and Ru⁴⁺, but are most typically Ru³⁺. Cerium cations may be in any suitable oxidation state, including Ce³⁺ and Ce⁴⁺. Without wishing to be bound by theory, it is believed that the cerium, manganese, or ruthenium cations persist in the polymer electrolyte because they are exchanged with H⁺ ions from the anion groups of the polymer electrolyte and become associated with those anion groups. Furthermore, it is believed that polyvalent cerium, manganese, or ruthenium cations may form crosslinks between anion groups of the polymer electrolyte, further adding to the stability of the polymer. In some embodiments, the salt may be present in solid form. The cations may be present in a combination of two or more forms including solvated cation, cation associated with bound anion groups of the polymer electrolyte membrane, and cation bound in a salt precipitate. The amount of salt added is typically between 0.001 and 0.5 charge equivalents based on the molar amount of acid functional groups present in the polymer electrolyte, more typically between 0.005 and 0.2, more typically between 0.01 and 0.1, and more typically between 0.02 and 0.05. Further details for combining an anionic copolymer with cerium, manganese, or ruthenium cations can be found in U.S. Pat. Nos. 7,575,534 and 8,628,871, each to Frey et al.

Polymer electrolyte membranes can also include cerium oxide compounds. The cerium oxide compound may contain cerium in the (IV) oxidation state, the (III) oxidation state, or both and may be crystalline or amorphous. The cerium oxide may be, for example, CeO₂ or Ce₂O₃. The cerium oxide may be substantially free of metallic cerium or may contain metallic cerium. The cerium oxide may be, for example, a thin oxidation reaction product on a metallic cerium particle. The cerium oxide compound may or may not contain other metal elements. Examples of mixed metal oxide compounds comprising cerium oxide include solid solutions such as zirconia-ceria and multicomponent oxide compounds such as barium cerate. Without wishing to be bound by theory, it is believed that the cerium oxide may strengthen the polymer by chelating and forming crosslinks between bound anionic groups. The amount of cerium oxide compound added is typically between 0.01 and 5 weight percent based on the total weight of the copolymer, more typically between 0.1 and 2 weight percent, and more typically between 0.2 and 0.3 weight percent. The cerium oxide compound is typically present in an amount of less than 1% by volume relative to the total volume of the polymer electrolyte membrane, more typically less than 0.8% by volume, and more typically less than 0.5% by volume. Cerium oxide may be in particles of any suitable size, in some embodiments, between 1 nm and 5000 nm, 200 nm to 5000 nm, or 500 nm to 1000 nm. Further details regarding polymer electrolyte membranes including cerium oxide compounds can be found in U.S. Pat. No. 8,367,267 (Frey et al.).

The polymer electrolyte membrane, in some embodiments of the solid article, may have a thickness of up to 90 microns, up to 60 microns, or up to 30 microns. A thinner membrane may provide less resistance to the passage of ions. In fuel cell use, this results in cooler operation and greater output of usable energy. Thinner membranes must be made of materials that maintain their structural integrity in use.

In some embodiments, the solid article includes a fluorinated polymer imbibed into a porous supporting matrix, typically in the form of a thin membrane having a thickness of up to 90 microns, up to 60 microns, or up to 30 microns. Any suitable method of imbibing the copolymer into the pores of the supporting matrix may be used, including overpressure, vacuum, wicking, and immersion. In some embodiments, the copolymer is embedded in the matrix upon crosslinking. Any suitable supporting matrix may be used. Typically, the supporting matrix is electrically non-conductive. Typically, the supporting matrix is composed of a fluoropolymer, which is more typically perfluorinated. Typical matrices include porous polytetrafluoroethylene (PTFE), such as biaxially stretched PTFE webs. In another embodiment fillers (e.g. fibers) might be added to the polymer to reinforce the membrane.

To make an MEA, GDL's may be applied to either side of a CCM by any suitable means. The solid article useful in the process of the present disclosure may include any suitable GDL. Typically, the GDL is comprised of sheet material comprising carbon fibers. Typically, the GDL is a carbon fiber construction selected from woven and non-woven carbon fiber constructions. Carbon fiber constructions which may be useful in the practice of the present disclosure may include Toray™ Carbon Paper, SpectraCarb™ Carbon Paper, AFN™ non-woven carbon cloth, and Zoltek™ Carbon Cloth. The GDL may be coated or impregnated with various materials, including carbon particle coatings, hydrophilizing treatments, and hydrophobizing treatments such as coating with PTFE.

In use, the MEA is typically sandwiched between two rigid plates, known as distribution plates, also known as bipolar plates (BPP's) or monopolar plates. In some embodiments, the solid article useful in the process of the present disclosure includes a bipolar plate. Like the GDL, the distribution plate is typically electrically conductive. The distribution plate is typically made of a carbon composite, metal, or plated metal material. The distribution plate distributes reactant or product fluids to and from the MEA electrode surfaces, typically through one or more fluid-conducting channels engraved, milled, molded or stamped in the surface(s) facing the MEA(s). These channels are sometimes designated a flow field. The distribution plate may distribute fluids to and from two consecutive MEA's in a stack, with one face directing fuel to the anode of the first MEA while the other face directs oxidant to the cathode of the next MEA (and removes product water), hence the term “bipolar plate.” Alternately, the distribution plate may have channels on one side only, to distribute fluids to or from an MEA on only that side, which may be termed a “monopolar plate.” A typical fuel cell stack comprises a number of MEA's stacked alternately with bipolar plates.

A fuel cell stack can also include a humidifier to control the temperature and humidity of the fuel streams. Humidifiers typically also include a membrane made from a fluorinated polymer having a fluorinated polymer backbone chain and a plurality of groups represented by formula —SO₃Z, wherein Z is as defined above. In some embodiments, the solid article useful in the process of the present disclosure is a membrane of a humidifier for a fuel cell.

Another type of electrochemical device is an electrolysis cell, which uses electricity to produce chemical changes or chemical energy. An example of an electrolysis cell is a chlor-alkali membrane cell where aqueous sodium chloride is electrolyzed by an electric current between an anode and a cathode. The electrolyte is separated into an anolyte portion and a catholyte portion by a membrane subject to harsh conditions. In chlor-alkali membrane cells, caustic sodium hydroxide collects in the catholyte portion, hydrogen gas is evolved at the cathode portion, and chlorine gas is evolved from the sodium chloride-rich anolyte portion at the anode. The solid article useful in the process of the present can comprise, for example, at least one of a catalyst ink or electrolyte membranes for use in chlor-alkali membrane cells or other electrolytic cells.

The solid article useful in the process of the present disclosure can also be a component of a flow battery (e.g., vanadium redox flow battery or a zinc-bromine flow battery). A flow battery typically uses electrolyte liquids pumped from separate tanks past a membrane between two electrodes. The electrolyte solutions are typically acidic and made with 2M to 5M sulfuric acid. In some embodiments, the solid article useful in the process of the present disclosure is a membrane of a redox flow device.

Water electrolyzers are electrochemical devices for producing hydrogen from water. These electrolyzers often contain MEAs similar to proton exchange membrane electrode assemblies for fuel cells. PEM based water electrolyzers, however, produce hydrogen at the cathode via a hydrogen evolution reaction (HER) and oxygen at the anode via an oxygen evolution reaction (OER). The designation of the electrodes as anode or cathode in an electrochemical device follows the IUPAC convention that the anode is the electrode at which the predominant reaction is oxidation (e.g., the H₂ oxidation electrode for a fuel cell, or the water oxidation/O₂ evolution reaction electrode for a water or CO₂ electrolyzer). Water electrolyzers often use iridium and ruthenium catalysts, particularly at the anode. In some embodiments, the solid article useful in the process of the present disclosure is a membrane of a water electrolyzer.

Membranes for chlor-alkali cells, flow batteries, and water electrolyzers are typically prepared in a similar manner to that described above for fuel cells. The membrane can be cast from a fluoropolymer dispersion including —SO₃Z groups, wherein Z is as defined above, and then dried, annealed, or both. After forming, the membrane may be annealed, typically at a temperature of 120° C. or higher, more typically 130° C. or higher, most typically 150° C. or higher. After this annealing, the fluorinated polymer is typically insoluble in water and water/alcohol mixtures at standard conditions as we report above. The membrane can also be made by extrusion of a fluorinated polymer precursor, which includes —SO₂F groups instead of —SO₃Z groups, followed by hydrolysis. Extrusion is also typically carried out at high temperatures, resulting in insolubility of the membrane after hydrolysis.

The process of the present disclosure includes heating the heat-treated solid article in the presence of water and base to form a fluorinated polymer salt solution and allowing the fluorinated polymer salt solution to cool. The base is typically an alkali metal hydroxide (e.g., lithium hydroxide, sodium hydroxide, or potassium hydroxide) or an ammonium hydroxide. In some embodiments, the base is lithium hydroxide or sodium hydroxide. Heating the heat-treated solid article in the presence of water and base can be carried out in any suitable reactor. For example, the heating may be carried out in an autoclave or other pressure vessel. The moles of base used may be equivalent to the moles of the fluorinated polymer, or an excess of base may be used. For example, an excess of up 300, 200, or 100 mole percent of base may be useful. The concentration of the fluorinated polymer salt in the fluorinated polymer salt solution can be in the range, for example, from 5 to 25, 10 to 25, 5 to 20, 10 to 20, or 10 to 15 percent by weight, based on the total weight of the fluorinated polymer salt solution.

The process of the present disclosure includes heating the heat-treated solid article in the presence of water and base. Any temperature suitable for forming a fluorinated polymer salt solution may be used. In some embodiments, heating is carried out at a temperature of at least 180° C., at least 200° C., or at least 225° C. In some embodiments, heating is carried out at a temperature up to 350° C., 325° C., 320° C., 310° C., or 300° C. In some embodiments, heating is carried out in a temperature range from 180° C. to 350° C., 200° C. to 350° C., 200° C. to 325° C., or 225° C. to 300° C. The temperature can be adjusted, for example, based on the composition of the fluorinated polymer, the pressure under which the reactor is operated, and the time for which the heating is carried out. The pressure in the reactor may be, for example, the vapor pressure of water at the temperature of the reaction. Heating the heat-treated solid article in the presence of water and base may be carried out for any suitable time to form a fluorinated polymer salt solution. In some embodiments, heating in the presence of water and based is carried out for up to 24, 12, 10, 5, 4, 3, or 2 hours. Allowing the fluorinated polymer salt solution to cool can be carried out, for example, by discontinuing heating for a time sufficient to cool to any desirable temperature (e.g., not more than 100° C., not more than 75° C., not more than 50° C., or room temperature).

Advantageously, heating the heat-treated solid article in the presence of water and base can be a solventless process. Organic solvents are typically not necessary to form the fluorinated polymer salt solution by heating the solid article in the presence of water and base. Solvents that may be avoided include lower alcohols (e.g., methanol, ethanol, isopropanol, n-propanol), polyols (e.g., C₁₋₈ diols, ethylene glycol, propylene glycol, glycerol), ethers (e.g., tetrahydrofuran and dioxane), ether acetates, acetonitrile, acetone, dimethylsulfoxide (DMSO), N,N dimethyacetamide (DMA), ethylene carbonate, propylene carbonate, dimethylcarbonate, diethylcarbonate, N,N-dimethylformamide (DMF), N-methylpyrrolidinone (NMP), dimethylimidazolidinone, butyrolactone, hexamethylphosphoric triamide (HMPT), isobutyl methyl ketone, sulfolane, and combinations thereof. The fluorinated polymer salt solution may be free of any of these solvents such as lower alcohols and polyols (e.g., C₁₋₈ diols). In some embodiments, the fluorinated polymer salt solution comprises up to five percent by weight organic solvent, including any of those described above such as lower alcohols and polyols (e.g., C₁₋₈ diols), based on the weight of the fluorinated polymer. In some embodiments, the fluorinated polymer salt solution comprises up to four, three, two, one, or 0.5 percent by weight organic solvent, including any of those described above such as lower alcohols and polyols (e.g., C₁₋₈ diols), based on the weight of the fluorinated polymer.

The process of the present disclosure further includes converting the fluorinated polymer salt solution to fluorinated polymer solution, wherein Z is hydrogen, using cation exchange. Cationic exchange may conveniently be carried out using a cation exchange resin. Useful cation exchange resins include polymers (typically cross-linked) that have a plurality of pendant anionic or acidic groups such as, for example, polysulfonates or polysulfonic acids, polycarboxylates or polycarboxylic acids. Examples of useful sulfonic acid cation exchange resins include sulfonated styrene-divinylbenzene copolymers, sulfonated crosslinked styrene polymers, phenol-formaldehyde-sulfonic acid resins, and benzene-formaldehyde-sulfonic acid resins. Carboxylic acid cation exchange resins are also useful. Cation exchange resins are available commercially from a variety of sources. Cation exchange resins are commonly supplied commercially in either their acid or their sodium form. If the cation exchange resin is not in the acid form (i.e., protonated form) it may be useful to at least partially or fully convert it to the acid form, which may be accomplished by known methods, for example, by treatment with any adequately strong acid.

After converting the fluorinated polymer salt solution to fluorinated polymer solution wherein Z is hydrogen using cation exchange, the fluorinated polymer can be recovered by drying, for example, if desired. Drying can be carried out at any temperature suitable to remove water, for example, a temperature up to 120° C., 100° C., 90° C., or 80° C.

In some embodiments, the cation content of the fluorinated polymer solution is not more than 500 parts per million (ppm), 400 ppm., 300 ppm, 200 ppm, or 100 ppm after converting the fluorinated polymer salt solution to fluorinated polymer solution wherein Z is hydrogen by cation exchange. In some embodiments, the multivalent cation (in some embodiments, metal ion) content of the fluorinated polymer solution is not more than 100 ppm, 75 ppm, 50 ppm, 25 ppm, 10 ppm, 5 ppm, or 1 ppm after converting the fluorinated polymer salt solution to fluorinated polymer solution wherein Z is hydrogen by cation exchange. The metal ion content of the fluorinated polymer can be measured by Inductively Coupled Plasma-Optical Emission Spectrometry after combusting the fluorinated polymer and dissolving the residue in an acidic aqueous solution as described in the Examples, below.

In some embodiments, the process of the present disclosure further comprises combining the heat-treated solid article with an inorganic acid to provide the fluorinated polymer wherein Z is hydrogen before heating the heat-treated solid article in the presence of water and base. Combining the heat-treated solid article with an inorganic acid can be useful for removing salts and any precipitated metals from the solid article and converting —SO₃⁻ groups to —SO₃H groups. Any suitable inorganic acid (e.g., HF, hydrochloric acid, nitric acid, or sulfuric acid) may be used. In some embodiments, combining the heat-treated solid article with the inorganic acid is carried out at an elevated temperature, for example, of at least 40° C., at least 50° C., or at least 75° C. In some embodiments, heating is carried out at a temperature up to 100° C., 90° C., or 80° C. In some embodiments, combining the heat-treated solid article with the inorganic acid is carried out at room temperature. Combining the heat-treated solid article with the inorganic acid can be carried out once or multiple (e.g., two or three) times.

In some embodiments, the process of the present disclosure further comprises at least one of crushing (e.g., milling or grinding) or shredding the heat-treated solid article before heating it in the presence of water and base and, in some embodiments, before combining the heat-treated solid article with an inorganic acid. The heat-treated solid article after at least one of crushing or milling can have a maximum dimension of up to 10 millimeters (mm), up to 5 mm, up to 3 mm, or up to 2 mm. When the heat-treated solid article is a component of a device comprising at least one of a catalyst ink, a catalyst layer, a gas diffusion layer, a bipolar plate, or a membrane of a membrane electrode assembly, a fuel cell, a chlor-alkali cell, or a redox flow device, the device can also be heated while simultaneously heating the fluorinated polymer in the presence of water and base. In these embodiments, at least one of crushing (e.g., milling or grinding) or shredding the device can be useful before heating it in the presence of water and base and, in some embodiments, before combining it with the inorganic acid.

Optionally, the fluorinated polymer salt solution may be at least one of filtered or centrifuged after it is cooled, for example, before converting the fluorinated polymer salt solution to the fluorinated polymer solution by cation exchange. Gravity and vacuum filtration may each be useful. Solid materials can be recovered from the heat-treated solid article. Solid materials that are desirable to recover include metals (e.g., precious metals) from catalyst inks or catalyst layers and graphite from bipolar plates, for example. In some embodiments, the process of the present disclosure further comprises recovering a metal after filtering the fluorinated polymer salt solution. The metal can be a precious metal (e.g., gold, silver, platinum, palladium, iridium, and/or ruthenium). The metals can be recovered from the collected solid by convenient methods, for example, by pyrolysis. In some embodiments, the metal content of the fluorinated polymer is not more than 100 ppm, 75 ppm, 50 ppm, or 25 ppm after converting the fluorinated polymer salt solution to fluorinated polymer solution wherein Z is hydrogen by cation exchange and optionally drying the fluorinated polymer solution.

The process of the present disclosure may be run as batch process or a continuous process.

Viscosity of a solution can be an indication of solubility of a fluorinated polymer, with increased viscosity indicating poorer solubility. In some embodiments, the fluorinated polymer solution wherein Z is hydrogen has a viscosity of up to 1000 mPa·sec at a steady shear rate of 1 second⁻¹ and a temperature of 20° C. as determined by the method described in the Examples, below, wherein the fluorinated polymer is present in the fluorinated polymer solution at a concentration of 15% to 20% by weight, based on the weight of the solution. In some embodiments, the fluorinated polymer solution wherein Z is hydrogen has a viscosity of up to 900, 800, 700, 600, or 500 mPa·sec at a steady shear rate of 1 second⁻¹ and a temperature of 20° C., wherein the fluorinated polymer is present in the fluorinated polymer solution at a concentration of 15% to 20% by weight, based on the weight of the solution. As shown in the Examples, below, after a fluorinated polymer is heat-treated at 190° C. for one hour, it is insoluble in water and water-alcohol mixtures. However, after the heat-treated polymer is treated by the process of the present disclosure by heating the heat-treated polymer in the presence of water and base to form a fluorinated polymer salt solution, allowing the fluorinated polymer salt solution to cool, and converting the fluorinated polymer salt solution to fluorinated polymer solution wherein Z is hydrogen by cation exchange, the viscosity of a 20% by weight solution of fluorinated polymer in 40 wt. % water/60 wt. % 1-propanol measured at a shear rate of 1 second⁻¹ was within the same order of magnitude of (e.g., less than three times or less than 2.5 times) the viscosity of the same fluorinated polymer before it was heat-treated.

Advantageously, the process of the present disclosure does not destroy the —SO₃Z groups in the fluorinated polymer. In some embodiments, the content of the —SO₃Z groups is reduced by less than ten, five, three, or two percent when the fluorinated polymer solution at the end of the process is compared with the fluorinated polymer in the heat-treated solid article at the beginning of the process. The content of the —SO₃Z groups is determined by nuclear magnetic resonance (NMR) spectroscopy, typically ¹⁹F-NMR spectroscopy using techniques known in the art.

The fluorinated polymer solution, wherein Z is hydrogen, can advantageously be used to prepare a catalyst ink, a catalyst layer, a gas diffusion layer, a bipolar plate, or a membrane of a membrane electrode assembly, a fuel cell, a humidifier, a water electrolyzer, a chlor-alkali cell, or a redox flow device using any of the methods described above. In some embodiments, the fluorinated polymer solution, wherein Z is hydrogen, can advantageously be used to prepare a catalyst ink or a membrane. Likewise, the fluorinated polymer recovered from the fluorinated polymer solution, wherein Z is hydrogen, by drying, for example, can advantageously be used to prepare a catalyst ink, a catalyst layer, a gas diffusion layer, a bipolar plate, or a membrane of a membrane electrode assembly, a fuel cell, a humidifier, a water electrolyzer, a chlor-alkali cell, or a redox flow device using any of the methods described above. In some embodiments, the fluorinated polymer, wherein Z is hydrogen, recovered from the fluorinated polymer solution by drying, for example, can advantageously be used to prepare a catalyst ink or a membrane.

The heat-treated solid article useful in the process of the present disclosure includes at least one fluorinated polymer. The fluorinated polymer has a fluorinated polymer backbone chain and a plurality of —SO₃Z, useful for providing ionic conductivity to the fluoropolymer. The —SO₃Z groups may be terminal groups on the fluorinated polymer backbone or may be part of one or more pendent groups. In the fluorinated polymer, each Z is independently a hydrogen, an alkali metal cation, or a quaternary ammonium cation. The quaternary ammonium cation can be substituted with any combination of hydrogen and alkyl groups, in some embodiments, alkyl groups independently having from one to four carbon atoms. In some embodiments of the heat-treated solid article, Z is an alkali-metal cation. In some embodiments of the heat-treated solid article, Z is a sodium or lithium cation. In some embodiments of the heat-treated solid article, Z is a sodium cation.

In some embodiments, at least some of the plurality of the groups represented by formula —SO₃Z are part of the side chains pendent from the fluorinated polymer backbone. In some embodiments, the side chains are represented by formula -Rp-SO₃Z, in which Z is as defined above in any of its embodiments, and Rp is bonded to the fluorinated polymer backbone and is a linear, branched, or cyclic perfluorinated or partially fluorinated alkyl or alkoxy group optionally interrupted by one or more —O— groups. Rp may typically comprise from 1 to 15 carbon atoms and from 0 to 4 oxygen atoms. The side chains may be derived from perfluorinated olefins, perfluorinated allyl ethers, or perfluorinated vinyl ethers bearing an —SO₃Z group or precursor, wherein the precursor groups may be subsequently converted into —SO₃Z groups.

### Examples of Suitable]-Rp Include

]—(CF₂)_{e′}—where e′ is 1, 2, 3, 4, 5, 6, 7, 8, 9, 10, 11, 12, 13, 14 or 15;
]—(CF₂CF(CF₃))_{e′}—where e′ is 1, 2, 3, 4, or 5;
]—(CF(CF₃)CF₂)_{e′}—where e′ is 1, 2, 3, 4, or 5;
]—(CF₂CF(CF₃)—)_{e′}—CF₂—where e′ is 1, 2, 3 or 4;
]—(CF₂)₀₋₁—(O—CF₂CF₂—)_{c′} where c′ is 1, 2, 3, 4, 5, 6 or 7;
]—(CF₂)₀₋₁—(O—CF₂CF₂CF₂—)_{c′} where c′ is 1, 2, 3, 4, or 5;
]—(CF₂)₀₋₁—(O—CF₂CF₂CF₂CF₂—)_{c′} where c′ is 1, 2 or 3;
]—(CF₂)₀₋₁—(O—CF₂CF(CF₃)—)_{c′} where c′ is 1, 2, 3, 4, or 5;
]—(CF₂)₀₋₁—(O—CF(CF₃)CF₂—)_{c′} where c′ is 1, 2, 3, 4 or 5;
]—(CF₂)₀₋₁—(O—CF(CF₂CF₃)CF₂—)_{c′} where c′ is 1, 2 or 3;
]—(CF₂)₀₋₁—(O—CF₂CF(CF₃)—)_{c′}—O—(CF₂)_{e′}—where c′ is 1, 2, 3 or 4 and e′ is 1 or 2;
]—(CF₂)₀₋₁—(O—CF₂CF(CF₂CF₃)—)_{c′}—O—(CF₂)_{e′}—where c′ is 1, 2 or 3 and e′ is 1 or 2;
]—(CF₂)₀₋₁—(O—CF(CF₃)CF₂—)_{c′}—O—(CF₂)_{e′}—where c′ is 1, 2, 3 or 4 and e′ is 1 or 2;
]—(CF₂)₀₋₁—(O—CF(CF₂CF₃)CF₂—)_{c′}—O—(CF₂)_{e′}—where c′ is 1, 2 or 3 and e′ is 1 or 2;
]—(CF₂)₀₋₁—)—(CF₂)_{e′}—where e′ is 1, 2, 3, 4, 5, 6, 7, 8, 9, 10, 11, 12, 13 or 14;
]—(CF₂)₀₋₁—O—CF₂—CF(O(CF₂)_{e′}—)CF₃ where e′ is 1, 2 or 3.

In some embodiments, the side chains pendent from the fluoropolymer backbone chain comprise at least one of —(CF₂)₀₋₁—O(CF₂)_{e′}SO₃Z with e′ being 1, 2, 3, 4 or 5, —(CF₂)₀₋₁—O(CF₂)₄SO₃Z, —(CF₂)₀₋₁—OCF₂CF(CF₃)OCF₂CF₂SO₃Z, and —(CF₂)₀₋₁—O—CF₂—CF(OCF₂CF₂SO₃Z)CF₃, wherein Z is as defined above in any of its embodiments.

Side chains pendent from the fluoropolymer backbone may be introduced by copolymerizing the corresponding sulfonyl-group containing monomers (in some embodiments, sulfonyl fluoride monomers) or by grafting the side groups to the backbone as described in U.S. Pat. No. 6,423,784 (Hamrock et al.). Suitable corresponding monomers include those according to the formula above where “]—” is replaced with “CZ₂═CZ—”, wherein Z is F or H. The sulfonyl fluoride monomers may be synthesized by standard methods, such as methods disclosed in U.S. Pat. No. 6,624,328 (Guerra et al.) and the references cited therein and the methods described below.

In some embodiments, the fluorinated polymer in the heat-treated solid article includes divalent units represented by formula —[CF₂—CF₂]—. In some embodiments, the fluorinated polymer comprises at least 60 mole % of divalent units represented by formula —[CF₂—CF₂]—, based on the total moles of divalent units. In some embodiments, the fluorinated polymer comprises at least 65, 70, 75, 80, or 90 mole % of divalent units represented by formula —[CF₂—CF₂]—, based on the total moles of divalent units. Divalent units represented by formula —[CF₂—CF₂]— are incorporated into the fluorinated polymer by copolymerizing components including tetrafluoroethylene (TFE). In some embodiments, the components to be polymerized include at least 60, 65, 70, 75, 80, or 90 mole % TFE, based on the total moles of components to be polymerized.

In some embodiments, the fluorinated polymer in the heat-treated solid article includes at least one divalent unit independently represented by formula:

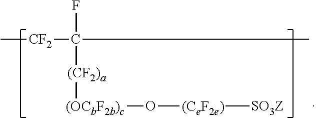

In this formula, a is 0 to 2, b is a number from 2 to 8, c is a number from 0 to 2, and e is a number from 1 to 8. In some embodiments, a is 0 or 1. In some embodiments, b is a number from 2 to 6 or 2 to 4. In some embodiments, b is 2. In some embodiments, e is a number from 1 to 6 or 2 to 4. In some embodiments, e is 2. In some embodiments, e is 4. In some embodiments, c is 0 or 1. In some embodiments, c is 0. In some embodiments, c is 0, and e is 2 or 4. In some embodiments, c is 0, and e is 3 to 8, 3 to 6, 3 to 4, or 4. In some embodiments, at least one of c is 1 or 2 or e is 3 to 8, 3 to 6, 3 to 4, or 4. In some embodiments, when a and c are 0, then e is 3 to 8, 3 to 6, 3 to 4, or 4. In some embodiments, b is 3, c is 1, and e is 2. In some embodiments, b is 2 or 3, c is 1, and e is 2 or 4. In some embodiments, a, b, c, and e may be selected to provide greater than 2, at least 3, or at least 4 carbon atoms. C_{b}F_{2b} and CₑF₂ₑ may be linear or branched. In some embodiments, CₑF₂ₑ can be written as (CF₂)ₑ, which refers to a linear perfluoroalkylene group. When c is 2, the b in the two C_{b}F_{2b} groups may be independently selected. However, within a C_{b}F_{2b} group, a person skilled in the art would understand that b is not independently selected. In any of these embodiments, each Z is independently a hydrogen, an alkali metal cation, or a quaternary ammonium cation. The quaternary ammonium cation can be substituted with any combination of hydrogen and alkyl groups, in some embodiments, alkyl groups independently having from one to four carbon atoms. In some embodiments, Z is an alkali-metal cation. In some embodiments, Z is a sodium or lithium cation. In some embodiments, Z is a sodium cation. In some embodiments, Z is hydrogen.

Fluorinated copolymers having divalent units represented by this formula can be prepared, for example, by copolymerizing components including at least one polyfluoroallyloxy or polyfluorovinyloxy compound represented by formula CF₂═CF(CF₂)ₐ—(OC_{b}F_{2b})_{c}—O—(CₑF₂ₑ)—SO₂X″, in which a, b, c, and e are as defined above in any of their embodiments, and each X″ is independently —F or —OZ. Hydrolysis of a copolymer having —SO₂F groups with an alkaline hydroxide (e.g. LiOH, NaOH, or KOH) solution provides —SO₃Z groups, which may be subsequently acidified to —SO₃H groups. Treatment of a copolymer having —SO₂F groups with water and steam can form —SO₃H groups. Suitable polyfluoroallyloxy and polyfluorovinyloxy compounds include CF₂═CFCF₂—O—CF₂—SO₂X″, CF₂═CFCF₂—O—CF₂CF₂—SO₂X″, CF₂═CFCF₂—O—CF₂CF₂CF₂—SO₂X″, CF₂═CFCF₂—O—CF₂CF₂CF₂CF₂—SO₂X″, CF₂═CFCF₂—O—CF₂CF(CF₃)—O—(CF₂)_{e′}—SO₂X″, CF₂═CF—O—CF₂—SO₂X″, CF₂═CF—O—CF₂CF₂—SO₂X″, CF₂═CF—O—CF₂CF₂CF₂—SO₂X″, CF₂═CF—O—CF₂CF₂CF₂CF₂—SO₂X″, and CF₂═CF—O—CF₂—CF(CF₃)—O—(CF₂)_{e′}—SO₂X″. In some embodiments, the compound represented by formula CF₂═CF(CF₂)ₐ—(OC_{b}F_{2b})_{c}—O—(CₑF₂ₑ)—SO₂X″ is CF₂═CFCF₂—O—CF₂CF₂—SO₂X″, CF₂═CF—O—CF₂CF₂—SO₂X″, CF₂═CFCF₂—O—CF₂CF₂CF₂CF₂—SO₂X″, or CF₂═CF—O—CF₂CF₂CF₂CF₂—SO₂X″. Compounds represented by formula CF₂═CF(CF₂)ₐ—(OC_{b}F_{2b})_{c}—O—(CₑF₂ₑ)—SO₂X″ can be made by known methods.

In some embodiments, the fluorinated polymer in the heat-treated solid article includes at least one divalent unit independently represented by formula:

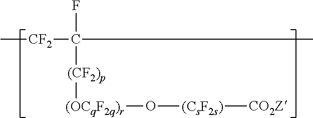

wherein p is 0 to 2, q is 2 to 8, r is 0 to 2, s is 1 to 8, and Z′ is a hydrogen, an alkali-metal cation, or a quaternary ammonium cation. In some embodiments, p is 0 or 1. In some embodiments, q is a number from 2 to 6 or 2 to 4. In some embodiments, q is 2. In some embodiments, s is a number from 1 to 6 or 2 to 4. In some embodiments, s is 2. In some embodiments, s is 4. In some embodiments, r is 0 or 1. In some embodiments, r is 0. In some embodiments, r is 0, and s is 2 or 4. In some embodiments, q is 3, r is 1, and s is 2. C_{q}F_{2q} and CₛF₂ₛ may be linear or branched. In some embodiments, CₛF₂ₛ can be written as (CF₂)ₛ, which refers to a linear perfluoroalkylene group. When r is 2, the q in the two C_{q}F_{2q} groups may be independently selected. However, within a C_{q}F_{2q} group, a person skilled in the art would understand that q is not independently selected. Each Z′ is independently a hydrogen, alkyl having up to 4, 3, 2, or 1 carbon atoms, an alkali metal cation, or a quaternary ammonium cation. The quaternary ammonium cation can be substituted with any combination of hydrogen and alkyl groups, in some embodiments, alkyl groups independently having from one to four carbon atoms. In some embodiments, Z′ is an alkali-metal cation. In some embodiments, Z′ is a sodium or lithium cation. In some embodiments, Z′ is a sodium cation. In some embodiments, Z′ is hydrogen. Fluorinated polymers having divalent units represented by this formula can be prepared, for example, by copolymerizing components including at least one polyfluoroallyloxy or polyfluorovinyloxy compound represented by formula CF₂═CF(CF₂)ₚ—(OC_{q}F_{2q})ᵣ—O—(CₛF₂ₛ)—COOZ′, in which p, q, r, s, and Z′ are as defined above in any of their embodiments. In some embodiments, the fluorinated polymer in the heat-treated solid article has not more than five, four, three, two, or one mole percent of units including carboxylate groups. In some embodiments, the fluorinated polymer in the heat-treated solid article is free of units including carboxylate groups.

The fluorinated polymer in the heat-treated solid article can have an —SO₃Z equivalent weight of up to 1500, 1400, 1300, or 1250. In some embodiments, the copolymer has an —SO₃Z equivalent weight of at least 500, 600, 700, 800, 900, 950, or 1000. In some embodiments, the copolymer has an —SO₃Z equivalent weight in a range from 500 to 1500, 600 to 1500, 500 to 1250, or 500 to 1000. In general, the —SO₃Z equivalent weight of the copolymer refers to the weight of the copolymer containing one mole of —SO₃Z groups, wherein Z is as defined above in any of its embodiments. In some embodiments, the —SO₃Z equivalent weight of the copolymer refers to the weight of the copolymer that will neutralize one equivalent of base. In some embodiments, the —SO₃Z equivalent weight of the copolymer refers to the weight of the copolymer containing one mole of sulfonate groups (i.e., —SO₃⁻). Decreasing the —SO₃Z equivalent weight of the copolymer tends to increase proton conductivity in the fluorinated polymer. Equivalent weight can be calculated from the molar ratio of monomer units in the fluorinated polymer and the molecular mass of the precursor monomer having the —SO₂F group.

The fluorinated polymer in the heat-treated solid article can have up to 30 mole percent of divalent units represented by formula

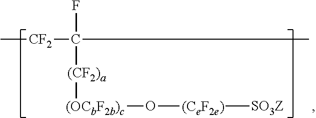

based on the total amount of the divalent units in the fluorinated polymer. In some embodiments, the fluorinated polymer comprises up to 25 or 20 mole percent of these divalent units. In some embodiments, the fluorinated polymer comprises at least 2, 5, or 10 mole percent of these divalent units. The copolymer can be prepared by copolymerizing components comprising up to 30 mole percent of at least one compound represented by formula CF₂═CF(CF₂)ₐ—(OC_{b}F_{2b})_{c}—O—(CₑF₂ₑ)—SO₂X″, in any of its embodiments described above, based on the total amount of components that are copolymerized.

In some embodiments of the fluorinated polymer in the heat-treated solid article, the fluorinated polymer includes divalent units represented by formula

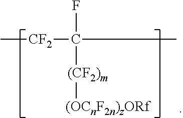

In this formula Rf is a linear or branched perfluoroalkyl group having from 1 to 8 carbon atoms and optionally interrupted by one or more —O— groups, z is 0, 1 or 2, each n is independently from 1 to 4, and m is 0 to 2. In some embodiments, m is 0 or 1. In some embodiments, n is 1, 3, or 4, or from 1 to 3, or from 2 to 3, or from 2 to 4. In some embodiments, when z is 2, one n is 2, and the other is 1, 3, or 4. In some embodiments, when a is 1 in any of the formulas described above, for example, n is from 1 to 4, 1 to 3, 2 to 3, or 2 to 4. In some embodiments, n is 1 or 3. In some embodiments, n is 1. In some embodiments, n is not 3. When z is 2, the n in the two CₙF₂ₙ groups may be independently selected. However, within a CₙF₂ₙ group, a person skilled in the art would understand that n is not independently selected. CₙF₂ₙ may be linear or branched. In some embodiments, CₙF₂ₙ is branched, for example, —CF₂—CF(CF₃)—. In some embodiments, CₙF₂ₙ can be written as (CF₂)ₙ, which refers to a linear perfluoroalkylene group. In these cases, the divalent units of this formula are represented by formula

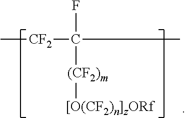

In some embodiments, CₙF₂ₙ is —CF₂—CF₂—CF₂—. In some embodiments, (OCₙF₂ₙ)_{z} is represented by —O—(CF₂)₁₋₄—[O(CF₂)₁₋₄]₀₋₁. In some embodiments, Rf is a linear or branched perfluoroalkyl group having from 1 to 8 (or 1 to 6) carbon atoms that is optionally interrupted by up to 4, 3, or 2 —O— groups. In some embodiments, Rf is a perfluoroalkyl group having from 1 to 4 carbon atoms optionally interrupted by one —O— group. In some embodiments, z is 0, m is 0, and Rf is a linear or branched perfluoroalkyl group having from 1 to 4 carbon atoms. In some embodiments, z is 0, m is 0, and Rf is a branched perfluoroalkyl group having from 3 to 8 carbon atoms. In some embodiments, m is 1, and Rf is a branched perfluoroalkyl group having from 3 to 8 carbon atoms or a linear perfluoroalkyl group having 5 to 8 carbon atoms. In some embodiments, Rf is a branched perfluoroalkyl group having from 3 to 6 or 3 to 4 carbon atoms. An example of a useful perfluoroalkyl vinyl ether (PAVE) from which these divalent units in which m and z are 0 are derived is perfluoroisopropyl vinyl ether (CF₂═CFOCF(CF₃)₂), also called iso-PPVE. Other useful PAVEs include perfluoromethyl vinyl ether, perfluoroethyl vinyl ether, and perfluoropropyl vinyl ether.

Divalent units represented by formulas

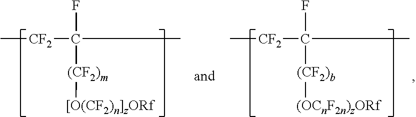

in which m is 0, can arise from perfluoroalkoxyalkyl vinyl ethers. Suitable perfluoroalkoxyalkyl vinyl ethers (PAOVE) include those represented by formula CF₂═CF[O(CF₂)ₙ]_{z}ORf and CF₂═CF(OCnF₂ₙ)_{z}ORf, in which n, z, and Rf are as defined above in any of their embodiments. Examples of suitable perfluoroalkoxyalkyl vinyl ethers include CF₂═CFOCF₂OCF₃, CF₂═CFOCF₂OCF₂CF₃, CF₂═CFOCF₂CF₂OCF₃, CF₂═CFOCF₂CF₂CF₂OCF₃, CF₂═CFOCF₂CF₂CF₂CF₂OCF₃, CF₂═CFOCF₂CF₂OCF₂CF₃, CF₂═CFOCF₂CF₂CF₂OCF₂CF₃, CF₂═CFOCF₂CF₂CF₂CF₂OCF₂CF₃, CF₂═CFOCF₂CF₂OCF₂OCF₃, CF₂═CFOCF₂CF₂OCF₂CF₂OCF₃, CF₂═CFOCF₂CF₂OCF₂CF₂CF₂OCF₃, CF₂═CFOCF₂CF₂OCF₂CF₂CF₂CF₂OCF₃, CF₂═CFOCF₂CF₂OCF₂CF₂CF₂CF₂CF₂OCF₃, CF₂═CFOCF₂CF₂(OCF₂)₃OCF₃, CF₂═CFOCF₂CF₂(OCF₂)₄OCF₃, CF₂═CFOCF₂CF₂OCF₂OCF₂OCF₃, CF₂═CFOCF₂CF₂OCF₂CF₂CF₃CF₂═CFOCF₂CF₂OCF₂CF₂OCF₂CF₂CF₃, CF₂═CFOCF₂CF(CF₃)—O—C₃F₇ (PPVE-2), CF₂═CF(OCF₂CF(CF₃))₂—O—C₃F₇(PPVE-3), and CF₂═CF(OCF₂CF(CF₃))₃—O—C₃F₇(PPVE-4). In some embodiments, the perfluoroalkoxyalkyl vinyl ether is selected from CF₂═CFOCF₂OCF₃, CF₂═CFOCF₂OCF₂CF₃, CF₂═CFOCF₂CF₂OCF₃, CF₂═CFOCF₂CF₂CF₂OCF₃, CF₂═CFOCF₂CF₂CF₂CF₂OCF₃, CF₂═CFOCF₂CF₂CF₂OCF₂CF₃, CF₂═CFOCF₂CF₂CF₂CF₂OCF₂CF₃, CF₂═CFOCF₂CF₂OCF₂OCF₃, CF₂═CFOCF₂CF₂OCF₂CF₂CF₂OCF₃, CF₂═CFOCF₂CF₂OCF₂CF₂CF₂CF₂OCF₃, CF₂═CFOCF₂CF₂OCF₂CF₂CF₂CF₂CF₂OCF₃, CF₂═CFOCF₂CF₂(OCF₂)₃OCF₃, CF₂═CFOCF₂CF₂(OCF₂)₄OCF₃, CF₂═CFOCF₂CF₂OCF₂OCF₂OCF₃, and combinations thereof. Many of these perfluoroalkoxyalkyl vinyl ethers can be prepared according to the methods described in U.S. Pat. No. 6,255,536 (Worm et al.) and U.S. Pat. No. 6,294,627 (Worm et al.). In some embodiments, the PAOVE is perfluoro-3-methoxy-n-propyl vinyl ether. In some embodiments, the PAOVE is other than perfluoro-3-methoxy-n-propyl vinyl ether.

The divalent units represented by formula

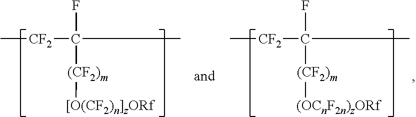

in which m is 1, can be derived from at least one perfluoroalkoxyalkyl allyl ether. Suitable perfluoroalkoxyalkyl allyl ethers include those represented by formula CF₂═CFCF₂(OCₙF₂ₙ)_{z}ORf, in which n, z, and Rf are as defined above in any of their embodiments. Examples of suitable perfluoroalkoxyalkyl allyl ethers include CF₂═CFCF₂OCF₂CF₂OCF₃, CF₂═CFCF₂OCF₂CF₂CF₂OCF₃, CF₂═CFCF₂OCF₂OCF₃, CF₂═CFCF₂OCF₂OCF₂CF₃, CF₂═CFCF₂OCF₂CF₂CF₂CF₂OCF₃, CF₂═CFCF₂OCF₂CF₂OCF₂CF₃, CF₂═CFCF₂OCF₂CF₂CF₂OCF₂CF₃, CF₂═CFCF₂OCF₂CF₂CF₂CF₂OCF₂CF₃, CF₂═CFCF₂OCF₂CF₂OCF₂OCF₃, CF₂═CFCF₂OCF₂CF₂OCF₂CF₂OCF₃, CF₂═CFCF₂OCF₂CF₂OCF₂CF₂CF₂OCF₃, CF₂═CFCF₂OCF₂CF₂OCF₂CF₂CF₂CF₂OCF₃, CF₂═CFCF₂OCF₂CF₂OCF₂CF₂CF₂CF₂CF₂OCF₃, CF₂═CFCF₂OCF₂CF₂(OCF₂)₃OCF₃, CF₂═CFCF₂OCF₂CF₂(OCF₂)₄OCF₃, CF₂═CFCF₂OCF₂CF₂OCF₂OCF₂OCF₃, CF₂═CFCF₂OCF₂CF₂OCF₂CF₂CF₃, CF₂═CFCF₂OCF₂CF₂OCF₂CF₂OCF₂CF₂CF₃, CF₂═CFCF₂OCF₂CF(CF₃)—O—C₃F₇, and CF₂═CFCF₂(OCF₂CF(CF₃))₂—O—C₃F₇. In some embodiments, the perfluoroalkoxyalkyl allyl ether is selected from CF₂═CFCF₂OCF₂CF₂OCF₃, CF₂═CFCF₂OCF₂CF₂CF₂OCF₃, CF₂═CFCF₂OCF₂OCF₃, CF₂═CFCF₂OCF₂OCF₂CF₃, CF₂═CFCF₂OCF₂CF₂CF₂CF₂OCF₃, CF₂═CFCF₂OCF₂CF₂OCF₂CF₃, CF₂═CFCF₂OCF₂CF₂CF₂OCF₂CF₃, CF₂═CFCF₂OCF₂CF₂CF₂CF₂OCF₂CF₃, CF₂═CFCF₂OCF₂CF₂OCF₂OCF₃, CF₂═CFCF₂OCF₂CF₂OCF₂CF₂OCF₃, CF₂═CFCF₂OCF₂CF₂OCF₂CF₂CF₂OCF₃, CF₂═CFCF₂OCF₂CF₂OCF₂CF₂CF₂CF₂OCF₃, CF₂═CFCF₂OCF₂CF₂OCF₂CF₂CF₂CF₂CF₂OCF₃, CF₂═CFCF₂OCF₂CF₂(OCF₂)₃OCF₃, CF₂═CFCF₂OCF₂CF₂(OCF₂)₄OCF₃, CF₂═CFCF₂OCF₂CF₂OCF₂OCF₂OCF₃, CF₂═CFCF₂OCF₂CF₂OCF₂CF₂CF₃, CF₂═CFCF₂OCF₂CF₂OCF₂CF₂OCF₂CF₂CF₃, and combinations thereof. Many of these perfluoroalkoxyalkyl allyl ethers can be prepared, for example, according to the methods described in U.S. Pat. No. 4,349,650 (Krespan) and Int. Pat. Appl. Pub. No. WO 2018/211457 (Hintzer et al.).

The fluorinated polymer in the heat-treated solid article can include divalent units derived from these vinyl ethers and allyl ethers in any useful amount, in some embodiments, in an amount of up to 15, 10, 7.5, or 5 mole percent, at least 3, 4, 4.5, 5, or 7.5 mole percent, or in a range from 3 to 15, 4 to 15, 4.5 to 15, 5 to 15, or 7.5 to 15 mole percent, based on the total moles of divalent units. In some embodiments, fluorinated polymers in the heat-treated solid article are free of divalent units represented by formula

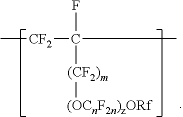

In some embodiments of the fluorinated polymer in the heat-treated solid article, the fluorinated polymer includes divalent units derived from at least one fluorinated olefin independently represented by formula C(R)₂═CF—Rf₂. These fluorinated divalent units are represented by formula —[CR₂—CFRf₂]—. In formulas C(R)₂═CF—Rf₂ and —[CR₂—CFRf₂]—, Rf₂ is fluorine or a perfluoroalkyl having from 1 to 8, in some embodiments 1 to 3, carbon atoms, and each R is independently hydrogen, fluorine, or chlorine. Some examples of fluorinated olefins useful as components of the polymerization include, hexafluoropropylene (HFP), trifluorochloroethylene (CTFE), and partially fluorinated olefins (e.g., vinylidene fluoride (VDF), tetrafluoropropylene (R1234yf), pentafluoropropylene, and trifluoroethylene). In some embodiments, the fluorinated polymer includes at least one of divalent units derived from chlorotrifluoroethylene or divalent units derived from hexafluoropropylene. Divalent units represented by formula —[CR₂—CFRf₂]— may be present in the fluorinated polymer in any useful amount, in some embodiments, in an amount of up to 10, 7.5, or 5 mole percent, based on the total moles of divalent units in the fluorinated polymer.

In some embodiments, the fluorinated polymer in the heat-treated solid article includes units derived from bisolefins represented by formula X₂C═CY—(CW₂)_{w}—(O)ᵣ—R_{F}—(O)_{y}—(CW₂)_{z}CY═CX₂. In this formula, each of X, Y, and W is independently fluoro, hydrogen, alkyl, alkoxy, polyoxyalkyl, perfluoroalkyl, perfluoroalkoxy or perfluoropolyoxyalkyl, w and z are independently an integer from 0 to 15, and x and y are independently 0 or 1. In some embodiments, X, Y, and W are each independently fluoro, CF₃, C₂F₅, C₃F₇, C₄F₉, hydrogen, CH₃, C₂H₅, C₃H₇, C₄H₉. In some embodiments, X, Y, and W are each fluoro (e.g., as in CF₂═CF—O—R_{F}—O—CF═CF₂ and CF₂═CF—CF₂—O—R_{F}—O—CF₂—CF═CF₂). In some embodiments, n and o are 1, and the bisolefins are divinyl ethers, diallyl ethers, or vinyl-allyl ethers. R_{F} represents linear or branched perfluoroalkylene or perfluoropolyoxyalkylene or arylene, which may be non-fluorinated or fluorinated. In some embodiments, R_{F} is perfluoroalkylene having from 1 to 12, from 2 to 10, or from 3 to 8 carbon atoms. The arylene may have from 5 to 14, 5 to 12, or 6 to 10 carbon atoms and may be non-substituted or substituted with one or more halogens other than fluoro, perfluoroalkyl (e.g. —CF₃ and —CF₂CF₃), perfluoroalkoxy (e.g. —O—CF₃, —OCF₂CF₃), perfluoropolyoxyalkyl (e.g., —OCF₂OCF₃; —CF₂OCF₂OCF₃), fluorinated, perfluorinated, or non-fluorinated phenyl or phenoxy, which may be substituted with one or more perfluoroalkyl, perfluoroalkoxy, perfluoropolyoxyalkyl groups, one or more halogens other than fluoro, or combinations thereof. In some embodiments, R_{F} is phenylene or mono-, di-, tri- or tetrafluoro-phenylene, with the ether groups linked in the ortho, para or meta position. In some embodiments, R_{F} is CF₂; (CF₂)_{q} wherein q is 2, 3, 4, 5, 6, 7 or 8; CF₂—O—CF₂; CF₂—O—CF₂—CF₂; CF(CF₃)CF₂; (CF₂)₂—O—CF(CF₃)—CF₂; CF(CF₃)—CF₂—O—CF(CF₃)CF₂; or (CF₂)₂—O—CF(CF₃)—CF₂—O—CF(CF₃)—CF₂—O—CF₂. The bisolefins can introduce long chain branches as described in U.S. Pat. Appl. Pub. No. 2010/0311906 (Lavallde et al.). The bisolefins, described above in any of their embodiments, may be present in the components to be polymerized in any useful amount, in some embodiments, in an amount of up to 2, 1, or 0.5 mole percent and in an amount of at least 0.1 mole percent, based on the total amount of polymerizable components to make the fluorinated polymer.

Fluorinated polymers in the heat-treated solid article are typically prepared by free-radical polymerization (e.g., radical aqueous emulsion polymerization suspension polymerization) using known methods.

In order that this disclosure can be more fully understood, the following examples are set forth. It should be understood that these examples are for illustrative purposes only and are not to be construed as limiting this disclosure in any manner.

### EXAMPLES

### Viscosity

The viscosities of the solutions were measured using a TA Instruments AR2000ex rheometer equipped with a 1°, 60-millimeter (mm) cone fixture and a Peltier plate assembly. The measurement was done at 20° C. and a steady shear rate of 1 second⁻¹ and 1000 second⁻¹. Data was taken every 10 seconds over a 60 second period, and the average is reported.

### Solids Content

Solids content in Example 4 was determined gravimetrically by placing samples of the dispersions on a heated balance and recording the mass before and after evaporation of solvent. The solid content was the ratio of the initial mass of the sample and the mass of the sample when the mass did not decrease further with continued heating.

### Water Content

Water content in Examples 1 to 3 was determined using a thermal balance.

Differential Scanning Calorimetry (DSC) The melting point of polytetrafluoroethylene in Example 4 was carried out by DSC using a DSC Q2000 (TA Instruments, New Castle, Del.) under a nitrogen flow. The first heat cycle started at −85° C. and was ramped to 350° C. at a 10° C./minute. The cooling cycle started at 350° C. and was cooled to −85° C. at 10° C./min. The second heat cycle started at −85° C. and was ramped to 350° C. at a 10° C./minute. A DSC thermogram was obtained from the second heat of a heat/cool/heat cycle to determine Tₘ.

### Inductively Coupled Plasma-Optical Emission Spectrometry (ICP-OES)

Cation concentrations (e.g., metals) were determined as follows. A sample was placed in a quartz glass vessel and ashed at 550° C. to remove the organic materials. The residue was dissolved in acid. Metal content was determined from the dissolved sample by ICP-OES using a ICAP 7400 DUO instrument from Thermo Fisher Scientific. Measurements were conducted according to DIN EN ISO 11885:2009-09.

Examples 1 to 3 were carried out with a copolymer of TFE and CF₂═CF—O—(CF₂)₄SO₃H having equivalent weights of 800, 725, and 980 obtained under the trade designations “3M IONOMER 800 EW”, “3M IONOMER 725 EW”, and “3M IONOMER 980 EW”, respectively, from 3M Company, St. Paul, Minn., USA.

### Reference Example 1

A virgin TFE/CF₂═CF—O—(CF₂)₄SO₃H polymer with an equivalent weight of 800 and containing 3 weight percent (wt. %) water was dissolved at 20 wt. % in water/1-propanol (40 wt. %/60 wt. %). The viscosity of this solution at a shear rate of 1 second⁻¹ (s⁻¹) was determined to be 80 megapascal·seconds (mPa·s) and at a shear rate of 1000 s⁻¹ 80 mPa·s using the test method described above.

### Illustrative Example 1

The virgin polymer in solid form was heated at 190° C. for 1 hour. The polymer was not soluble anymore in water or water/1-propanol (40 wt. %/60 wt. %) even at temperatures up to about 80° C.

### Example 1

The heat-treated polymer (25 grams (g)), 5.4 g LiOH·1 H₂O, and 200 g water were put in an autoclave and heated for 3 hours at 250° C. The pressure was 36 bar (3.6 megapascals). After cooling to room temperature, the polymer was completely dissolved. The resulting solution was passed through a cation-exchange bed, filled with “PUROLITE 150 CTLH” (H+ form) ion exchange resin (Purolite, King of Prussia, Pa.) to convert the

—SO₃⁻Li+ form of the polymer into the —SO₃H form. The solution was then dried at 70° C. to obtain a dry polymer (containing 6 wt. % water). This polymer was dissolved at 20 wt. % in water/1-propanol (40 wt. %/60 wt. %). The viscosity of this solution at a shear rate of 1 second⁻¹ (s⁻¹) was determined to be 200 mPa·s and at a shear rate of 1000 s⁻¹ was determined to be 150 mPa·s using the test method described above.

### Reference Examples (RE) and Examples 2 and 3 (Ex. 2 and 3)

Examples 2 and 3 were carried out as described for Example 1 using a TFE/CF₂═CF—O—(CF₂)₄SO₃H polymer having the equivalent weight (EW) and water content (wt. %) shown in Table 1, below. The viscosities at 15 wt. % in water/1-propanol (40 wt. %/60 wt. %) for Ex. 2 and 20 wt. % in water/1-propanol (40 wt. %/60 wt. %) for Ex. 3 of the virgin polymer (RE) and the heat-treated polymer treated according to the method described in Example 1 (Ex.) are shown in Table 1, below.

TABLE 1

| RE | | RE | RE | Ex. | Ex |
|---|---|---|---|---|---|
| or | EW/water | viscosity | viscosity | viscosity | viscosity |
| Ex. | wt. % | 1 s⁻¹ | 1000 s⁻¹ | 1 s⁻¹ | 1000 s⁻¹ |
| 2 | 725/8 | 390 mPa · s | 230 mPa · s | 250 mPa · s | 170 mPa · s |
| 3 | 980/8 | 60 mPa · s | 60 mPa · s | 140 mPa · s | 120 mPa · s |

### Example 4

A polytetrafluoroethylene (PTFE) fabric-reinforced ion exchange membrane (having a fluorinated polymer backbone chain and a plurality of groups represented by formula —SO₃Z, EW=1100) previously used in chlorine/alkaline electrolysis with the dimensions 125 centimeters (cm) by 240 cm by 240 micrometers was cut into small pieces and placed in 10% hydrochloric acid for 24 hours and rinsed with demineralized water. The pieces were placed in 10% hydrochloric acid for 24 hours and rinsed with demineralized water two more times. Then the membrane pieces were air dried.

The membrane pieces (47 g), 5.4 g of LiOH·1 H₂O, and 200 g of water were transferred to a high-pressure autoclave and heated at 260° C. for 3 hours. The pressure was 36 bar (3.6 megapascals). After cooling to room temperature, the solution was filtered through a folded filter, and the filter residue was analyzed by Differential Scanning Calorimetry (DSC). The DSC showed a melt peak typical of PTFE at 327° C. The filtrate solution (203 g) had a solids content of 10% by weight. The filtrate solution was passed through a cation-exchange bed, filled with “PUROLITE 150 CTLH” (H+ form) ion exchange resin to convert the —SO₃⁻Li+ form of the membrane into the —SO₃H form. The ion-exchanged solution was then dried at 60° C. for 20 h to obtain a dry membrane material (H₂O content: 9 wt. %). This membrane material was dissolved at 20 wt. % in water/1-propanol (40 wt. %/60 wt. %). The viscosity of this solution at a shear rate of 1 s⁻¹ was determined to be 34 mPa·s and at a shear rate of 1000 s⁻¹ was determined to be 36 mPa·s using the test method described above. The dry membrane material was analyzed by ICP-OES according to the method described above and found to have the following ion contents: Fe=15 parts per million (ppm), Ni=5 ppm, Cu=0.2 ppm, Cr=0.3 ppm, Zn=0.3 ppm, Mn=0.3 ppm Co<0.1 ppm; total 21.1 ppm.

Various modifications and alterations of this disclosure may be made by those skilled in the art without departing from the scope and spirit of the disclosure, and it should be understood that this invention is not to be unduly limited to the illustrative embodiments set forth herein.

1. A process for recycling a heat-treated solid article comprising a fluorinated polymer having a fluorinated polymer backbone chain and a plurality of groups represented by formula —SO₃Z, wherein Z is independently a hydrogen, an alkali-metal cation, or a quaternary ammonium cation, the heat-treated solid article having been heated at a temperature of at least 100° C., the process comprising:
heating the heat-treated solid article in the presence of water and base to form a fluorinated polymer salt solution;
allowing the fluorinated polymer salt solution to cool; and
converting the fluorinated polymer salt solution to a fluorinated polymer solution wherein Z is hydrogen by cation exchange.

2. The process of claim 1, wherein heating the heat-treated solid article in the presence of water and base is carried out at a temperature of at least 180° C.

3. The process of claim 1, wherein heating the heat-treated solid article in the presence of water and base is carried out at a temperature of up to 350° C.

4. The process of claim 1, further comprising combining the heat-treated solid article with an inorganic acid to provide the fluorinated polymer wherein Z is hydrogen before heating the heat-treated solid article in the presence of water and base.

5. The process of claim 1, further comprising at least one of crushing or shredding the heat-treated solid article before heating it in the presence of water and base.

6. The process of claim 1, wherein the fluorinated polymer salt solution comprises up to five percent by weight organic solvent, based on the weight of the fluorinated polymer.

7. The process of claim 1, further comprising at least one of filtering or centrifuging the fluorinated polymer salt solution after allowing it to cool and before converting the fluorinated polymer salt solution to the fluorinated polymer solution wherein Z is hydrogen by cation exchange.

8. The process of claim 7, further comprising recovering metal comprising at least one of gold, silver, platinum, palladium, iridium, or ruthenium after at least one of filtering or centrifuging the fluorinated polymer salt solution.

9. The process of claim 1, wherein the solid article is a component of a device comprising at least one of a catalyst ink, a catalyst layer, a gas diffusion layer, a bipolar plate, or a membrane of a membrane electrode assembly, a fuel cell, a humidifier, a water electrolyzer, a chlor-alkali cell, or a redox flow device.

10. The process of claim 1, wherein the fluorinated polymer solution wherein Z is hydrogen has a viscosity of up to 1000 megapascal·seconds at a steady shear rate of 1 second⁻¹ and a temperature of 20° C., wherein the fluorinated polymer is present in the fluorinated polymer solution at a concentration of 15% to 20% by weight.

11. The process of claim 1, wherein the fluorinated polymer comprises:
divalent units represented by formula —[CF₂—CF₂]—; and
divalent units independently represented by formula: 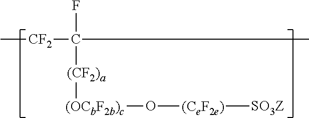
wherein a is 0 to 2, b is 2 to 8, c is 0 to 2, e is 1 to 8, and Z is independently a hydrogen, an alkali-metal cation, or a quaternary ammonium cation.

12. The process of claim 11, wherein the fluorinated polymer further comprises:
one or more divalent units independently represented by formula: 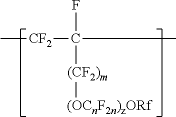
wherein Rf is a linear or branched perfluoroalkyl group having from 1 to 8 carbon atoms and optionally interrupted by one or more —O— groups, z is 0, 1, or 2, each n is independently 1, 2, 3, or 4, and m is 0 to 2.

13. The process of claim 11, wherein the fluorinated polymer further comprises not more than five mole percent divalent units independently represented by formula: 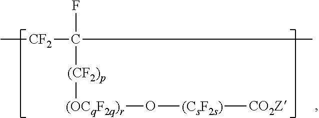
wherein p is 0 to 2, each q is independently 2 to 8, r is 0 to 2, s is 1 to 8, and Z′ is a hydrogen, an alkali-metal cation, or a quaternary ammonium cation.

14. The process of claim 1, wherein the fluorinated polymer has an —SO₃Z equivalent weight in a range from 500 to 1500.

15. The process of claim 1, further comprising drying the fluoropolymer after converting the fluorinated polymer salt solution to the fluorinated polymer solution wherein Z is hydrogen by cation exchange.

16. The process of claim 1, wherein the cation content of the fluorinated polymer solution is not more than 500 parts per million after converting the fluorinated polymer salt solution to the fluorinated polymer solution wherein Z is hydrogen by cation exchange.

17. The process of claim 1, wherein the multivalent cation content of the fluorinated polymer solution is not more than 100 parts per million after converting the fluorinated polymer salt solution to the fluorinated polymer solution wherein Z is hydrogen by cation exchange.

18. The process of claim 1, wherein the process reduces the content of the groups represented by formula —SO₃Z in the fluorinated polymer by not more than ten percent.

19. The process of claim 1, further comprising using fluorinated polymer solution wherein Z is hydrogen to prepare at least one of a catalyst ink or a membrane of a membrane electrode assembly, a fuel cell, a humidifier, a water electrolyzer, a chlor-alkali cell, or a redox flow device.
